(19) United States
(12) Patent Application Publication
(10) Pub. No.: US 2026/0260371 A1
(43) Pub. Date: Sep. 3, 2026

(54) SEARCH APPARATUS, SEARCH METHOD, AND NON-TRANSITORY RECORDING MEDIUM

(71) Applicant: NEC Corporation, Minato-ku, Tokyo (JP)

(72) Inventors: Yuya KOIBUCHI, Tokyo (JP); Hirohito ASAKURA, Tokyo (JP)

(73) Assignee: NEC Corporation, Minato-ku, Tokyo (JP)

(21) Appl. No.: 18/878,687

(22) PCT Filed: Jun. 23, 2023
(86) PCT No.: PCT/JP2023/023389

§ 371 Date: Dec. 24, 2024

(30) Foreign Application Priority Data
Jun. 29, 2022 (JP) 2022-104556

(51) Int. Cl. G06T 7/70

(52) U.S. Cl. CPC G06T 7/70

(57) ABSTRACT

A search apparatus includes: an acquisition unit that acquires first state information indicating a state in a first predetermined range including time and space in which a first search target appears; and an output unit that outputs first position information indicating a position regarding the first search target located in the first predetermined range, wherein the output unit inputs the first state information acquired by the acquiring unit into a search model, and causes the search model to output the first position information, and the search model is generated by machine learning using teacher data including: second state information indicating a state in a second predetermined range including time and space in which a second search target appears; and second position information indicating a position regarding the second search target located in the second predetermined range.

This application is a National Stage Entry of PCT/JP 2023/023389 filed on Jun. 23, 2023, which claims priority from Japanese Patent Application 2022-104556 filed on Jun. 29, 2022, the contents of all of which are incorporated herein by reference, in their entirety.

### TECHNICAL FIELD

This disclosure relates to technical fields of a search apparatus, a search method, and a recording medium.

### BACKGROUND ART

Patent Literature 1 describes a technique/technology of suitably assisting in investigation such that criminal cases can be solved without requiring skilled investigators, by including an estimation unit that estimates a type of a second incident, based on an estimation model representing a relationship between a type of the first incident and action history information (representing a time-series change of actions of related persons) and/or human relation information (representing a time-series change of human relations of related persons) about a first incident, and based on action history information and human relation information about the second incident. Patent Literature 2 describes a technique/technology of: acquiring locus information representing a movement locus of an object in a time series image; acquiring state information representing a state around the object in the time series image; acquiring a search query including the movement locus and the state around the object; and searching for an image meeting the search query among images included in the time series image on the basis of the locus information and the state information, thereby more properly searching for a desired scene. Patent Literature 3 describes a technique/technology of converting a collection of non-RFID tagged evidence into RFID tagged evidence, the method including the steps of: providing evidence including a non-RFID tag; obtaining information from the non-RFID tag; inputting the information into a processor; writing the information to an RFID tag; associating a database record with the RFID tag.

### CITATION LIST

### Patent Literature

Patent Literature 1: International Publication No. WO2021/199101

Patent Literature 2: JP2018-081630A

Patent Literature 3: JP2004-531796A

### SUMMARY

### Technical Problem

It is an example object of this disclosure to provide a search apparatus, a search method, and a recording medium that aim to improve the techniques/technologies disclosed in Citation List.

### Solution to Problem

A search apparatus according to an example aspect includes: an acquisition unit that acquires first state information indicating a state in a first predetermined range including time and space in which a first search target appears; and an output unit that outputs first position information indicating a position regarding the first search target located in the first predetermined range, wherein the output unit inputs the first state information acquired by the acquiring unit into a search model, and causes the search model to output the first position information, and the search model is generated by machine learning using teacher data including: second state information indicating a state in a second predetermined range including time and space in which a second search target appears; and second position information indicating a position regarding the second search target located in the second predetermined range.

A search method according to an example aspect includes: acquiring first state information indicating a state in a first predetermined range including time and space in which a first search target appears; and outputting first position information indicating a position regarding the first search target located in the first predetermined range, wherein the outputting is performed by inputting the first state information acquired into a search model, and by causing the search model to output the first position information, and the search model is generated by machine learning using teacher data including: second state information indicating a state in a second predetermined range including time and space in which a second search target appears; and second position information indicating a position regarding the second search target located in the second predetermined range.

A recording medium according to an example aspect is a recording medium on which a computer program that allows a computer to execute a search method is recorded, the search method including: acquiring first state information indicating a state in a first predetermined range including time and space in which a first search target appears; and outputting first position information indicating a position regarding the first search target located in the first predetermined range, wherein the outputting is performed by inputting the first state information acquired into a search model, and by causing the search model to output the first position information, and the search model is generated by machine learning using teacher data including: second state information indicating a state in a second predetermined range including time and space in which a second search target appears; and second position information indicating a position regarding the second search target located in the second predetermined range.

### BRIEF DESCRIPTION OF DRAWINGS

FIG. 1 is a block diagram illustrating a configuration of a search apparatus according to a first example embodiment.

FIG. 2 is a block diagram illustrating a configuration of a search apparatus according to a second example embodiment.

FIG. 3 is a flowchart illustrating a flow of a model generating operation performed by the search apparatus according to the second example embodiment.

FIG. 4 is a flowchart illustrating a flow of a search assisting operation performed by the search apparatus according to the second example embodiment.

FIG. 5A is a diagram illustrating input and output examples by the search apparatus according to the second example embodiment.

FIG. 5B according to the second example embodiment.

FIG. 6A is a diagram illustrating input and output examples by a search apparatus according to a third example embodiment.

FIG. 6B is a diagram illustrating input and output examples by a search apparatus according to a third example embodiment.

FIG. 7 is a block diagram illustrating a configuration of a search apparatus according to a fourth example embodiment.

FIG. 8 is a flowchart illustrating a flow of a search assisting operation performed by the search apparatus according to the fourth example embodiment.

FIG. 9A is a diagram illustrating a presentation example presented by the search apparatus according to the fourth example embodiment.

FIG. 9B is a diagram illustrating a presentation example presented by the search apparatus according to the fourth example embodiment.

FIG. 10 is a flowchart illustrating a flow of a search assisting operation performed by a search apparatus according to a fifth example embodiment.

FIG. 11A is a diagram illustrating a presentation example presented by the search apparatus according to the fifth example embodiment.

FIG. 11B is a diagram illustrating a presentation example presented by the search apparatus according to the fifth example embodiment.

FIG. 12 is a flowchart illustrating a flow of a search assisting operation performed by a search apparatus according to a sixth example embodiment.

FIG. 13A is a diagram illustrating an output example outputted by the search apparatus according to the sixth example embodiment.

FIG. 13B is a diagram illustrating an output example outputted by the search apparatus according to the sixth example embodiment.

### DESCRIPTION OF EXAMPLE EMBODIMENTS

Hereinafter, a search apparatus, a search method, and a recording medium according to example embodiments will be described with reference to the drawings.

### 1: First Example Embodiment

A search apparatus, a search method, and a recording medium according to a first example embodiment will be described. The following describes the search apparatus, the search method, and the recording medium according to the first example embodiment will be described, by using a search apparatus 1 to which the search apparatus, the search method, and the recording medium according to the first example embodiment are applied.

### 1-1: Configuration of Search Apparatus 1

With reference to FIG. 1, a configuration of the search apparatus 1 according to the first example embodiment will be described. FIG. 1 is a block diagram illustrating the configuration of the search apparatus 1 according to the first example embodiment.

As illustrated in FIG. 1, the search apparatus 1 includes an acquisition unit 11 and an output unit 12. The acquisition unit 11 acquires first state information indicating a state in a first predetermined range including time and space in which a first search target appears. The output unit 12 outputs first position information indicating a position regarding the first search target located in the first predetermined range. The output unit 12 inputs the first state information acquired by the acquisition unit 11 into a search model, and causes the search model to output the first position information. The search model is generated by machine learning using teacher data including: second state information indicating a state in a second predetermined range including time and space in which a second search target appears; and second position information indicating a position regarding the second search target located in the second predetermined range.

### 1-2: Technical Effect of Search Apparatus 1

Since the search apparatus 1 according to the first example embodiment outputs the first position information indicating the position regarding the first search target located in the first predetermined range including the time and space in which the first search target appears, by using the search model generated by the machine learning, it is possible to reduce a workload of the search for the first search target.

### 2: Second Example Embodiment

A search apparatus, a search method, and a recording medium according to a second example embodiment will be described. The following describes the search apparatus, the search method, and the recording medium according to the second example embodiment will be described, by using a search apparatus 2 to which the search apparatus, the search method, and the recording medium according to the second example embodiment are applied.

### 2-1: Configuration of Search Apparatus 2

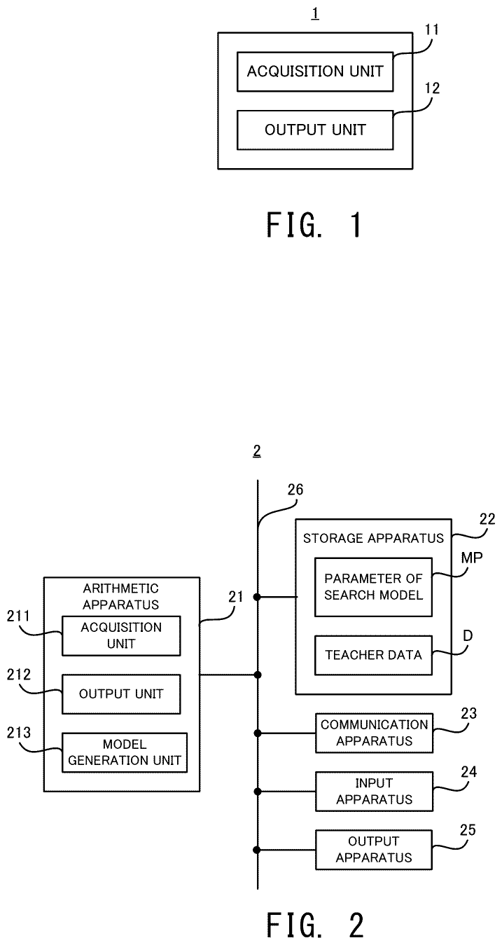

With reference to FIG. 2, a configuration of the search apparatus 2 according to the second example embodiment will be described. FIG. 2 is a block diagram illustrating the configuration of the search apparatus 2 according to the second example embodiment.

As illustrated in FIG. 2, the search apparatus 2 includes an arithmetic apparatus 21 and a storage apparatus 22. Furthermore, the search apparatus 2 may include a communication apparatus 23, an input apparatus 24, and an output apparatus 25. The communication apparatus 23, however, may not include at least one of the input apparatus 24 and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the search apparatus 2 (e.g., the input apparatus 24 described later). The arithmetic apparatus 21 may acquire (i.e., download or read) a computer program from a not-illustrated apparatus disposed outside the search apparatus 2 via a communication apparatus 23 (or another communication apparatus). The arithmetic apparatus 21 executes the read computer program. Consequently, a logical functional block for performing an operation to be performed by the search apparatus 2 is realized or implemented in the arithmetic apparatus 21. That is, the arithmetic apparatus 21 is allowed to function as a controller for realizing or implementing the logical functional block for performing an operation (in other words, processing) to be performed by the search apparatus 2.

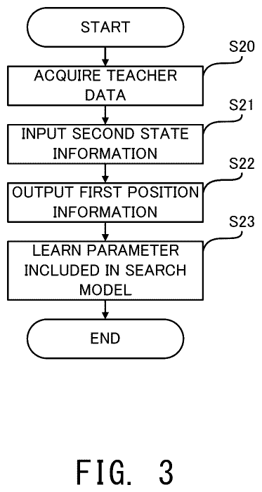

FIG. 2 illustrates an example of the logical functional block realized or implemented in the arithmetic apparatus 21 to perform a search assisting operation. As illustrated in FIG. 2, an acquisition unit 211 that is a specific example of an “acquisition unit” described in Supplementary Note later, an output unit 212 that is a specific example of the “output unit” described in Supplementary Note later, and a model generation unit 213 that is a specific example of the “model generation unit” described in Supplementary Note later, are realized or implemented in the arithmetic apparatus 21. In the arithmetic apparatus 21, however, the model generation unit 213 may not be realized or implemented. Operation of each of the acquisition unit 211, the output unit 212, and the model generation unit 213 will be described later with reference to FIG. 3 to FIG. 5B.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the search apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium. The storage apparatus 22 may store at least one of a parameter MP described later and teacher data D.

The communication apparatus 23 is configured to communicate with an apparatus external to the search apparatus 2 via a not-illustrated communication network. The communication apparatus 23 may be a communication interface based on a standard such as Ethernet (registered trademark), Wi-Fi (registered trademark), Bluetooth (registered trademark), and USB (Universal Serial Bus).

The input apparatus 24 is an apparatus that receives an input of information to the search apparatus 2 from an outside of the search apparatus 2. For example, the input apparatus 24 may include an operating apparatus (e.g., at least one of a keyboard, a mouse trackball, a touch panel, a pointing device such as a pen tablet, a button, and the like) that is operable by an operator of the search apparatus 2. For example, the input apparatus 24 may include a reading apparatus that is configured to read information recorded as data on a recording medium that is externally attachable to the search apparatus 2.

The output apparatus 25 is an apparatus that outputs information to the outside of the search apparatus 2. For example, the output apparatus 25 may output information as an image. That is, the output apparatus 25 may include a display apparatus (a so-called display) that is configured to display an image indicating the information that is desirably outputted. An example of the display apparatus may be a liquid crystal display, an OLED (Organic Light Emitting Diode) display, or the like. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface. The input apparatus 24 and the output apparatus 25 may be integrally formed as a touch panel.

The hardware configuration illustrated in FIG. 2 is an example. An apparatus other than the apparatus illustrated in FIG. 2 may be added, and a part of the apparatus may not be provided. In addition, a part of the apparatus may be replaced with another apparatus having a similar function. In addition, a part of the function in the second example embodiment may be provided by another apparatus via a network. The function in the second example embodiment may be distributed to and realized in a plurality of apparatuses. Thus, the hardware configuration illustrated in FIG. 2 may be changed as appropriate.

### 2-2: Model Generating Operation Performed by Search Apparatus 2

With reference to FIG. 3, a flow of a model generating operation performed by the search apparatus 2 according to the second example embodiment will be described. FIG. 3 is a flowchart illustrating the flow of the model generating operation performed by the search apparatus 2 according to the second example embodiment.

As illustrated in FIG. 3, the acquisition unit 211 acquires the teacher data D including: the second state information indicating the state in the second predetermined range including the time and space in which the second search target appears; and the second position information indicating the position regarding the second search target located in the second predetermined range (step S20). The time and space in which the second search target appears, may be, for example, a location of an incident such as an accident and a crime. In this instance, the second search target may be evidence regarding the incident. The evidence regarding the incident may include, for example, latent fingerprints, items left behind, or the like. The position regarding the second search target may include at least one of a position at which the second search target is located and a position at which the second search target is likely to be located. The second position information may be, for example, information indicating a position at which the evidence regarding the incident may remain. The acquisition unit 211 may acquire the teacher data D stored in the storage apparatus 22.

The output unit 212 inputs the second state information included in the teacher data D acquired by the acquisition unit 211, into the search model (step S21).

The output unit 212 causes the search model to output the first position information indicating the position regarding the second search target located in the second predetermined range (step S22).

The model generation unit 213 adjusts a parameter MP included in the search model and generates the search model, based on the first position information outputted by the search model and based on the second position information included in the teacher data D acquired by the acquisition unit 211 (step S23). The model generation unit 213 may adjust the parameter MP included in the search model such that the second position information outputted by the search model is similar to the second position information included in the teacher data D acquired by the acquisition unit 211. That is, the model generation unit 213 may adjust the parameter MP included in the search model by performing machine learning using the teacher data D including the second state information and the second position information, and may generate the search model. In other words, the search model is generated by the machine learning using the teacher data D including the second state information and the second position information.

A model generation apparatus that is different from the search apparatus 2 may perform the model generating operation. In such a case, the search apparatus 2 may acquire, from the model generation apparatus, a search model generated by the model generation apparatus. In addition, the search apparatus 2 may not include the model generation unit 213.

### 2-3: Search Assisting Operation Performed by Search Apparatus 2

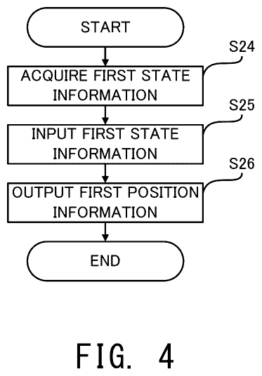

With reference to FIG. 4, a flow of a search assisting operation performed by the search apparatus 2 according to the second example embodiment will be described. FIG. 4 is a flowchart illustrating the flow of the search assisting operation performed by the search apparatus 2 according to the second example embodiment.

As illustrated in FIG. 4, the acquisition unit 211 acquires the first state information indicating the state in the first predetermined range including the time and space in which the first search target appears (step S24). The time and space in which the first search target appears, may be, for example, an incident scene. In this instance, the first search target may be the evidence regarding the incident.

The output unit 212 inputs the first state information acquired by the acquisition unit 211 into the search model (step S25).

The output unit 212 causes the search model to output the first position information indicating the position (sometimes referred to as a “first position”) regarding the first search target located in the first predetermined range (step S26). That is, the output unit 212 outputs the first position information indicating the position regarding the first search target located in the first predetermined range. The first position may include at least one of a position at which the first search target is located and a position at which the first search target is likely to be located.

The position at which the first search target may be located, varies depending on the state in the first predetermined range including the time and space in which the first search target appears. Therefore, the search apparatus 2 according to the second example embodiment uses the state in the first predetermined range including the time and space in which the first search target appears, to estimate the first position.

When the first position is a location where the evidence is hardly collected by human, a user using the first position information may direct a drone or robot to the first position, for example. In that case, the drone or robot performs a movement control with the first position as a destination.

### 2-4: Input and Output Examples by Search Apparatus 2

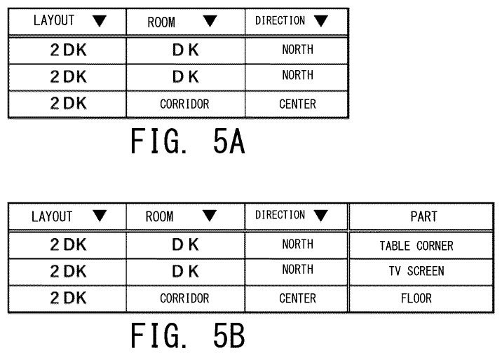

FIGS. 5A and 5B is a diagram illustrating input and output examples by the search apparatus 2 according to the second example embodiment. The acquisition unit 211 may acquire character information serving as the first state information. The first predetermined range including the time and space in which the first search target appears, may be a building including the location of an incident. In this instance, the acquisition unit 211 may acquire, as the first state information, character information indicating arrangement of closed spaces such as rooms in the first predetermined range, as illustrated in FIG. 5A. As exemplified in FIG. 5A, the character information indicating the arrangement of rooms may include character information indicating house layout such as 2DK, and character information indicating a direction of each room, for example. The first state information acquired by the acquisition unit 211 may include character information indicating an entry route of an intruder and character information indicating a date and time of the incident.

The first state information may be information entered by a user operation. The acquisition unit 211 may be a mechanism that acquires the first state information received by the input apparatus 24. The first state information may be inputted by a pull-down operation by the user, for a touch panel mounted on a smartphone carried by the user, or the like, for example.

The output unit 212 may output character information serving as the first position information. As illustrated in FIG. 5B, the output unit 212 may output the character information indicating the first position information, alongside the character information indicating the first state information. FIG. 5B exemplifies an output in which the search target is easily found on a “table corner” and a “TV screen” in a “DK” located “north” in a house layout of “2DK” and in which the search target is easily found on a “floor” in a “corridor” located in a “center” in the layout of “2DK”.

The output unit 212 may be a control mechanism that causes the output apparatus 25 to output the first position information. For example, the output unit 212 may output the character information serving as the first position information, to a display mounted on the smartphone carried by the user, or the like. The output 212 may also output information indicating what the evidence is.

### 2-5: Technical Effect of Search Apparatus 2

For example, when a forensic investigator collects the evidence in the location of the incident, the forensic investigator is required to make assumptions from various points of view and find traces as the evidence, and thus, the forensic investigator often has a heavy workload. In addition, the assumptions based on the state in the location of the incident or the like, is often dependent on past experience. It is thus hard for an unexperienced forensic investigator to find sufficient evidence. For example, in a case of an intrusion into an inside, an experienced forensic investigator knows, as the past experience, that a position at which the evidence is likely to be found is a window frame where fingerprints are likely to be collected because an intruder often puts his hands on the window frame. In addition, in the case of the intrusion into the inside, the experienced forensic investigator knows, as the past experience, that the position at which the evidence is likely to be found is a garden where footmarks are likely to be collected because the intruder often passes through the garden.

Since the search apparatus 2 according to the second example embodiment outputs the first position information indicating the position regarding the first search target located in the first predetermined range, it is possible to teach the forensic investigator, who is a user, the position at which the evidence is likely to be found, thereby reducing the workload of the forensic investigator. Especially, even in the case of the unexperienced forensic investigator, it is possible to assist in finding sufficient evidence.

### 3: Third Example Embodiment

A search apparatus, a search method, and a recording medium according to a third example embodiment will be described. The following describes the search apparatus, the search method, and the recording medium according to the third example embodiment will be described, by using a search apparatus 3 to which the search apparatus, the search method, and the recording medium according to the third example embodiment are applied.

The search apparatus 3 according to the third example embodiment is different from the search apparatus 2 according to the second example embodiment, in an input target and an output target. Other features of the search apparatus 3 may be the same as those of the search apparatus 3

### 3-1: Input and Output Examples by Search Apparatus 3

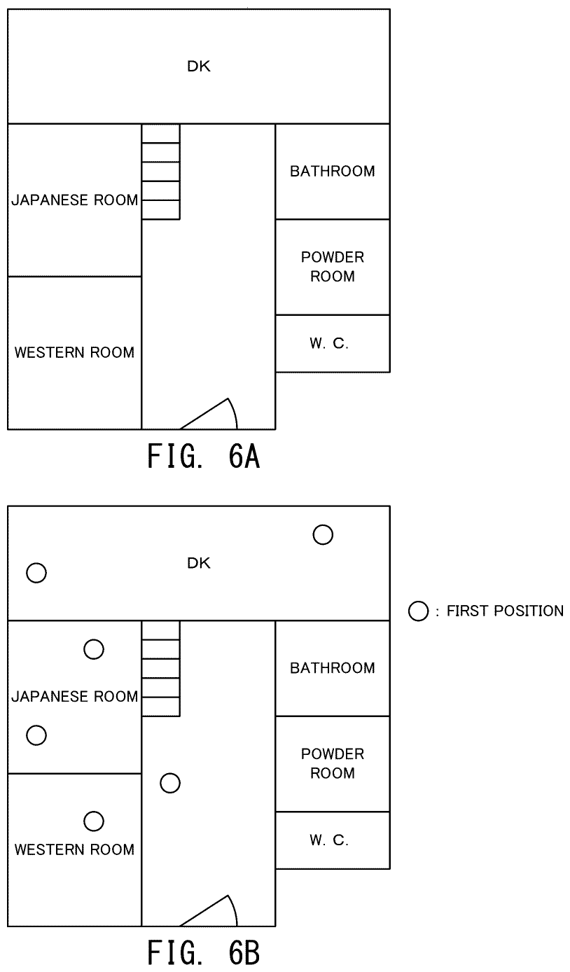

FIGS. 6A and 6B is a diagram illustrating input/output examples by the search apparatus 3 according to the third example embodiment. In the third example embodiment, the first state information may be information about an image of the first predetermined range including the time and space in which the first search target appears. The first predetermined range including the time and space in which the first search target appears, may be a building including the location of the incident. In this instance, the acquisition unit 211 may acquire, as the first state information, information about an image indicating the arrangement of closed spaces such as rooms in the first predetermined range, as illustrated in FIG. 6A. The first state information acquired by the acquisition unit 211 may also include information indicating an entry route of an intruder and information indicating a date and time of the incident.

The acquisition unit 211 may acquire a floor plan serving as the first state information generated by an autonomous mobile robot. The autonomous mobile robot may autonomously patrol closed spaces, for example, a building or rooms in the building, and may produce a floor plan of a building or rooms in a building. The autonomous mobile robot may be equipped with a camera, and may generate the floor plan based on captured images. The autonomous mobile robot may be equipped with at least one of a position detecting device such as a GPS (Global Positioning System) sensor and an attitude detecting device such as an acceleration sensor, and may generate the floor plan based on a detection result. The autonomous mobile robot may generate a two-dimensional floor plan. The autonomous mobile robot may be a flying object such as a drone, and may generate a three-dimensional floor plan.

The output unit 212 may output an image as the first position information. As illustrated in FIG. 6B, the output unit 212 may superimpose and output a circle indicating the first position, as the first position, on an image indicating the first predetermined range. The output unit 212 may further superimpose and output information indicating what the evidence is.

### 3-2: Model Generating Operation Performed by Search Apparatus 3

The model generation unit 213 may adjust a parameter included in a search model by performing machine learning using the teacher data D including the second position information and information about an image of the second predetermined range including the time and space in which the second search target appears, and may generate the search model.

### 3-3: Technical Effect of Search Apparatus 3

Since the search apparatus 3 according to the third example embodiment is allowed to provide the user with the information about the image, it is possible to improve the user's convenience.

### 4: Fourth Example Embodiment

A search apparatus, a search method, and a recording medium according to a fourth example embodiment will be described. The following describes the search apparatus, the search method, and the recording medium according to the fourth example embodiment will be described, by using a search apparatus 4 to which the search apparatus, the search method, and the recording medium according to the fourth example embodiment are applied.

### 4-1: Configuration of Search Apparatus 4

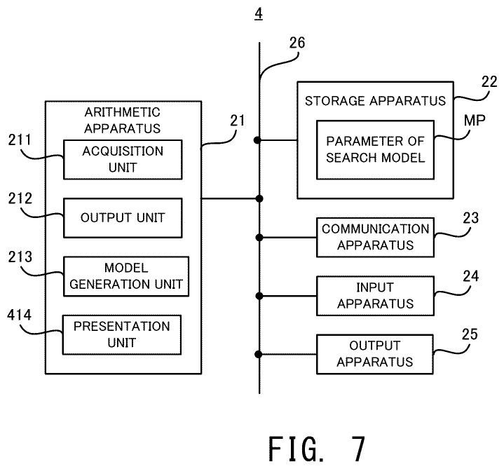

With reference to FIG. 7, a configuration of the search apparatus 4 according to the fourth example embodiment will be described. FIG. 7 is a block diagram illustrating the configuration of the search apparatus 4 according to the fourth example embodiment.

As illustrated in FIG. 7, the search apparatus 4 according to the fourth example embodiment includes the arithmetic apparatus 21 and the storage apparatus 22, as in the search apparatus 2 according to the second example embodiment and the search apparatus 3 according to the third example embodiment. In addition, the search apparatus 4 may include the communication apparatus 23, the input apparatus 24, and the output apparatus 25, as in the search apparatus 2 according to the second example embodiment and the search apparatus 3 according to the third example embodiment. The search apparatus 4, however, may not include at least one of the communication apparatus 23, the input apparatus 24, and the output apparatus 25. The search apparatus 4 according to the fourth example embodiment is different from the search apparatus 2 according to the second example embodiment and the search apparatus 3 according to the third example embodiment, in that the arithmetic apparatus 21 includes a presentation unit 414. Other features of the search apparatus 4 may be the same as those of at least one of the search apparatus 2 according to the second example embodiment and the search apparatus 3 according to the third example embodiment.

### 4-2: Presentation Operation by Search Apparatus 4

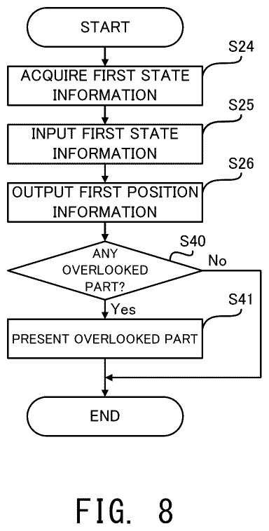

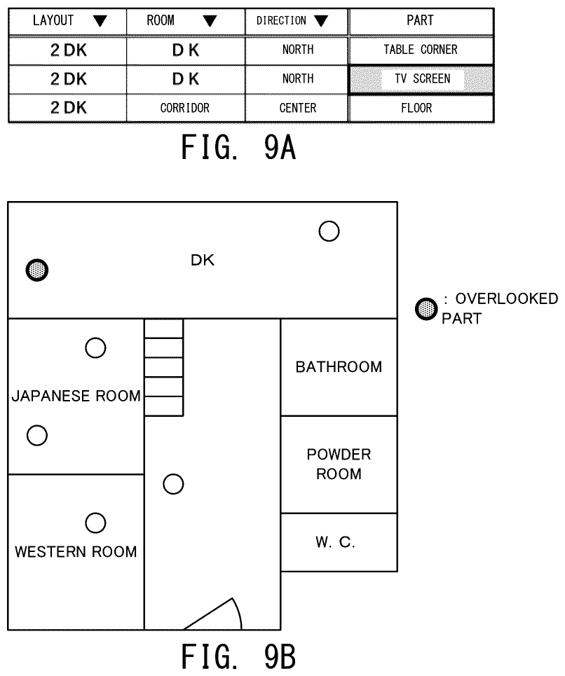

With reference to FIG. 8 and FIGS. 9A and 9B, a flow of a presentation operation performed by the search apparatus 4 according to the fourth example embodiment will be described. FIG. 8 is a flowchart illustrating the flow of the presentation operation performed by the search apparatus 4 according to the fourth example embodiment.

As illustrated in FIG. 8, the acquisition unit 211 acquires the first state information indicating the state in the first predetermined range including the time and space in which the first search target appears (step S24). The output unit 212 inputs the first state information acquired by the acquisition unit 211 into the search model (step S25), and the output unit 212 causes the search model to output the first position information indicating the position regarding the first search target located in the first predetermined range (step S26). In the step S26, the output unit 212 may output the character information serving as the first position information, as illustrated in FIG. 5B. The output unit 212 may also output an image serving as the first position information, as illustrated in FIG. 6B.

The presentation unit 414 determines whether or not there is a position indicated by the first position information and not confirmed by the user using the first position information (also referred to as an “overlooked part”) (step S40). When there is an overlooked part (the step S40: Yes), the presentation unit 414 presents the position indicated by the corresponding first position information, as the overlooked part that is unlikely to be confirmed by the user (step S41). When there is no overlooked part (the step S40: No), the search assisting operation in the fourth example embodiment is ended.

FIGS. 9A and 9B is a diagram illustrating a presentation example presented by the search apparatus 4 according to the fourth example embodiment. FIG. 9A illustrates a case where the output unit 212 outputs the character information serving as the first position information. As illustrated in FIG. 9A, when the “TV screen” in the “DK” is an overlooked part, the presentation unit 414 may highlight an area in the corresponding frame.

FIG. 9B illustrates a case where the output unit 212 outputs the image serving as the first position information. As illustrated in FIG. 9B, when the “TV screen” in the “DK” is an overlooked part, the presentation unit 414 may highlight a circle indicating the corresponding position.

The presentation unit 414 may also present the overlooked part by displaying an arrow indicating the overlooked part or the like, on a head-mounted display, a smart glass, or the like worn by the user.

The operation in the step S40 may be performed, for example, in response to an input by the user indicating the completion of the search operation.

### 4-3: Technical Effect of Search Apparatus 4

Since the search apparatus 4 according to the fourth example embodiment presents, to the user, the first position that is not confirmed by the user, as the overlooked part, it is possible to prevent the user from overlooking the first position.

### 5: Fifth Example Embodiment

A search apparatus, a search method, and a recording medium according to a fifth example embodiment will be described. The following describes the search apparatus, the search method, and the recording medium according to the fifth example embodiment will be described, by using a search apparatus 5 to which the search apparatus, the search method, and the recording medium according to the fifth example embodiment are applied.

The search apparatus 5 according to the fifth example embodiment is different from the search apparatus 4 according to the fourth example embodiment, in the presentation operation performed by the presentation unit 414. Other features of the search apparatus 5 may be the same as those of the search apparatus 4

### 5-1: Presentation Operation by Search Apparatus 5

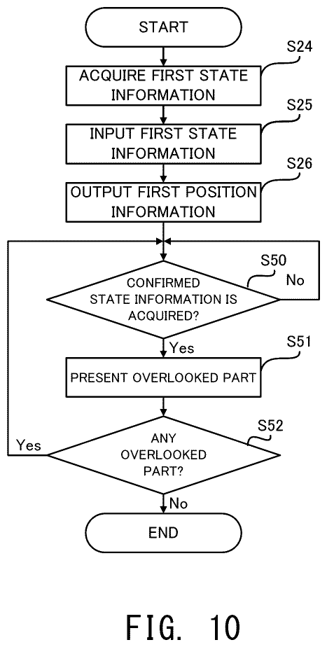

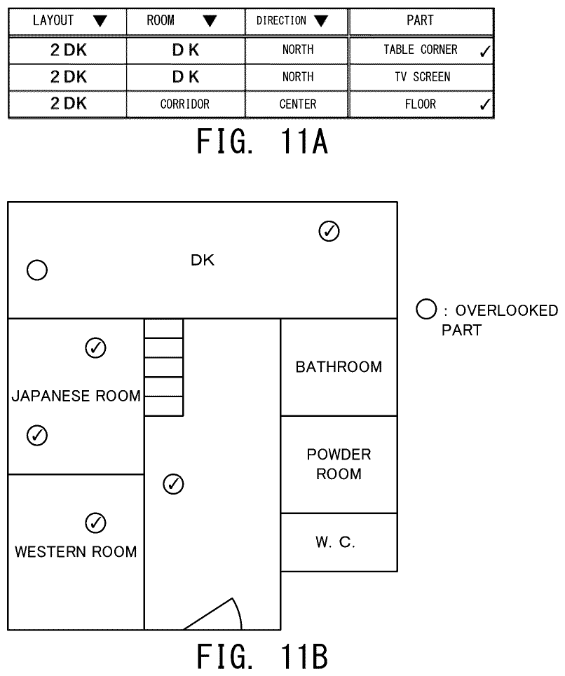

With reference to FIG. 10 and FIGS. 11A and 11B, a flow of a presentation operation performed by the search apparatus 5 according to the fifth example embodiment will be described. FIG. 10 is a flowchart illustrating the flow of the presentation operation performed by the search apparatus 5 according to the fifth example embodiment.

As illustrated in FIG. 10, the acquisition unit 211 acquires the first state information indicating the state in the first predetermined range including the time and space in which the first search target appears (step S24). The output unit 212 inputs the first state information acquired by the acquisition unit 211 into the search model (step S25), and the output unit 212 causes the search model to output the first position information indicating the position regarding the first search target located in the first predetermined range (step S26). In the step S26, the output unit 212 may output the character information serving as the first position information, as illustrated in FIG. 5B. The output unit 212 may also output the image serving as the first position information, as illustrated in FIG. 6B.

The display unit 414 determines whether or not confirmed state information is acquired (step S50). The confirmed state information may include at least one of information about a checklist indicating a position confirmed by the user in the first predetermined range and information about a movement of the user in the first predetermined range. The presentation unit 414 may collect a log of the movement of the user, by using a detection device including at least one of a position detection device, such as a GPS (Global Positioning System) sensor, mounted on a terminal device carried by the user, and an attitude detection device such as an acceleration sensor.

When the confirmed state information is acquired (the step S50: Yes), the presentation unit 414 presents the overlooked part, based on the confirmed state information (step S51). Specifically, the presentation unit 414 determines whether there is an overlooked part, based on the confirmed state information. For example, when the information about the checklist that is an example of the confirmed state information, indicates that the user does not confirm the position of the first search target indicated by the first position information, the presentation unit 414 may identify the position of the first search target indicated by the first position information, as the overlooked part. For example, when the information about the movement of the user that is an example of the confirmed state information, indicates that the user does not pass the position of the first search target indicated by the first position information, the presentation unit 414 may identify the position of the first search target indicated by the first position information, as the overlooked part. Thereafter, the presentation unit 414 may superimpose a checkmark on the information indicating the first position information outputted by the output unit 212 and may present the overlooked part. When the confirmed state information is not acquired (the step S50: No), the processing returns to the step S50.

FIGS. 11A and 11B is a diagram illustrating a presentation example presented by the search apparatus 5 according to the fifth example embodiment. FIG. 11A illustrates a case where the output unit 212 outputs the character information serving as the first position information. As illustrated in FIG. 11A, when the “table corner” in the “DK” and the “floor” in the “corridor” are confirmed, the presentation unit 414 may superimpose a checkmark in the corresponding frame. That is, the presentation unit 414 may present a part on which a checkmark is not superimposed, as the overlooked part.

FIG. 11B illustrates a case where the output unit 212 outputs the image serving as the first position information. As illustrated in FIG. 11B, when the “table corner” in the “DK” and the “floor” in the “corridor” or the like are confirmed, the presentation unit 414 may superimpose a checkmark on a circle indicating the corresponding position. That is, the presentation unit 414 may present a circle on which a checkmark is not superimposed, as the overlooked point.

The presentation unit 414 determines whether or not there is an overlooked part (step S52). The presentation unit 414 may determine whether there is an overlooked part, by determining whether or not there is a position on which a checkmark is not superimposed. When there is an overlooked part (the step S52: Yes), the processing returns to the step S50. When there is no overlooked part (the step S52: No), the search assisting operation is ended.

The presentation unit 414 may also present the overlooked part by displaying an arrow indicating the overlooked part or the like, on a head-mounted display, a smart glass, or the like worn by the user.

### 5-2: Technical Effect of Search Apparatus 5

Since the search apparatus 5 according to the fifth example embodiment presents the overlooked part to the user located at the first position, based on at least one of the information about the checklist and the information about the movement of the user, more certainly.

### 6: Sixth Example Embodiment

A search apparatus, a search method, and a recording medium according to a sixth example embodiment will be described. The following describes the search apparatus, the search method, and the recording medium according to the sixth example embodiment will be described, by using a search apparatus 6 to which the search apparatus, the search method, and the recording medium according to the sixth example embodiment are applied.

The search apparatus 6 according to the sixth form is different from the search apparatus 2 according to the second example embodiment and the search apparatus 5 according to the fifth example embodiment, in the content outputted by the output unit 212. Other features of the search apparatus 6 may be the same as those of at least one of the search apparatus 2 according to the second example embodiment to the search apparatus 5 according to the fifth example embodiment.

### 6-1: Search Assisting Operation and Model Generating Operation by Search Apparatus 6

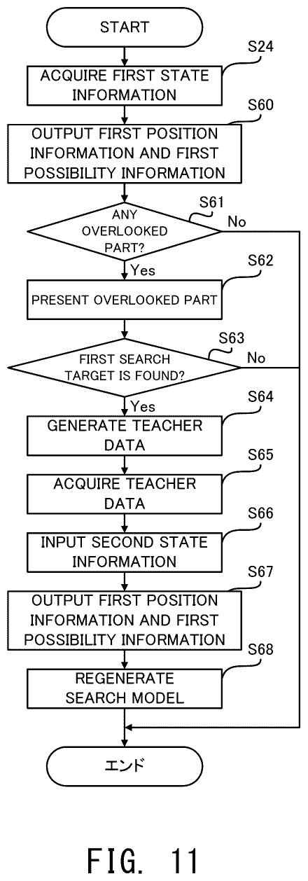

With reference to FIG. 12, a flow of a learning operation performed by the search apparatus 6 according to the sixth example embodiment will be described. FIG. 12 is a flowchart illustrating the flow of the learning operation performed by the search apparatus 6 according to the sixth example embodiment.

As illustrated in FIG. 12, the acquisition unit 211 acquires the first state information indicating the state in the first predetermined range including the time and space in which the first search target appears (step S24).

The output unit 212 inputs the first state information acquired by the acquisition unit 211 into the search model, and causes the search model to output the first position information and first possibility information about a possibility of the user overlooking the position indicated by the first position information (step S60).

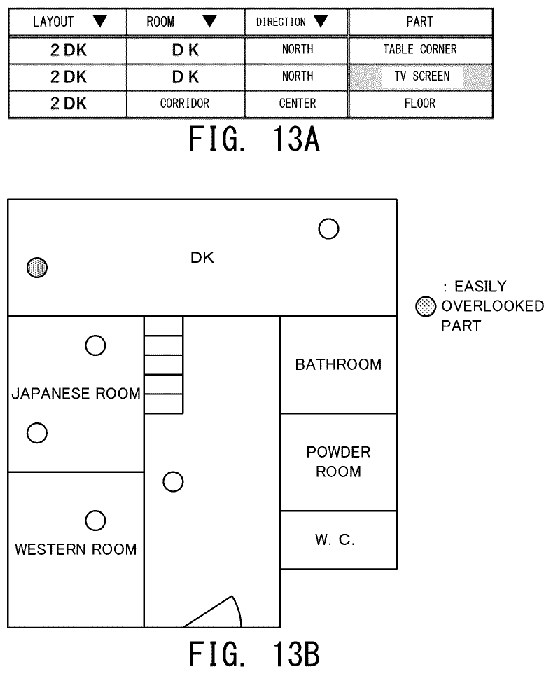

FIGS. 13A and 13B is a diagram illustrating an output example outputted by the search apparatus 6 according to the sixth example embodiment. FIG. 13A illustrates a case where the output unit 212 outputs the character information serving as the first position information. For example, when the first possibility information indicates that a possibility of the user overlooking the “TV screen” in the “DK” is greater than a predetermined value, the output unit 212 may highlight an inside of the frame of the “TV screen” in the “DK”, as illustrated in FIG. 13A.

FIG. 13B illustrates a case where the output unit 212 outputs the image serving as the first position information. For example, when the first possibility information indicates that a possibility of the user overlooking the “TV screen” in the “DK” is greater than a predetermined value, the output unit 212 may highlight a circle indicating the position of the “TV screen” in the “DK”, as illustrated in FIG. 13A.

The presentation unit 414 determines whether or not there is an overlooked part (step S61). When there is an overlooked part (the step S61: Yes), the presentation unit 414 presents the overlooked part to the user (step S62). The presentation unit 414 may present the overlooked part to the user, as in the presentation examples illustrated in FIGS. 9A and 9B and FIGS. 11A and 11B.

After the first position serving as the overlooked part is presented to the user, the model generation unit 213 determines whether or not the user finds the first search target at the first position (step S63).

When the user finds the first search target at the first position (the step S63: Yes), the model generation unit 213 generates the teacher data D (step S64). The teacher data D generated in the step S64 includes the first state information and the first position information, respectively as the second state information and the second position information. In addition, the teacher data D generated in the step S64 further includes second possibility information indicating that a possibility of the user overlooking the position indicated by the second position information is greater than a predetermined value.

The acquisition unit 211 acquires the teacher data D generated in the step S64 (step S65).

The output unit 212 inputs the second state information included in the teacher data D generated in the step S64 acquired by the acquisition unit 211, into the search model (step S66).

The output unit 212 causes the search model to output the first position information indicating the position regarding the second search target located in the second predetermined range, and the first possibility information about the possibility of the user overlooking the position indicated by the first position information (step S67).

The model generation unit 213 regenerates the search model by the machine learning using the teacher data D (step S68). The model generator 213 may adjust the parameter MP included in the search model, and may regenerate the search model. The model generation unit 213 may adjust the parameter MP included in the search model, based on the first position information outputted by the search model, the second position information included in the teacher data D acquired by the acquisition unit 211, the first possibility information outputted by the search model, and the second possibility information included in the teacher data D acquired by the acquisition unit 211. The model generation unit 213 may adjust the parameter MP included in the search model such that the first position information outputted by the search model is similar to the second position information included in the teacher data D acquired by the acquisition unit 211, and such that the first possibility information outputted by the search model is similar to the second possibility information included in the teacher data D acquired by the acquisition unit 211. That is, the model generation unit 213 may adjust the parameter MP included in the search model by performing machine learning using the teacher data D including the second state information, the second position information, and the second possibility information, and may regenerate the search model. In other words, the search model is regenerated by the machine learning using the teacher data D including the second state information, the second position information, and the second possibility information.

### 6-2: Technical Effect of Search Apparatus 6

Since the search apparatus 6 according to the sixth example embodiment outputs the first possibility information in addition to the first position information, it is possible to make the user previously recognize a position easily overlooked by the user. In addition, when the user finds the search target at the position presented to the user as the overlooked part, the search apparatus 6 regenerates the search model by the machine learning using the teacher data D including the first state information, the first position information, and the first possibility information, respectively as the second state information, the second position information, and the second possibility information. It is therefore possible to provide information that allows the user to further find the search target.

Each of the above example embodiments exemplifies a case where the time and space in which the search target appears is the location of an incident such as an accident and a crime, and the search target is evidence of the incident. Each example embodiment, however, may be applied to a search case in an incident other than the accident and the crime. For example, the search target may be a missing person including a missing child, and the time and space at which the search target appears may be a position, a time zone, or the like in which the missing person is seen. In this case, the search model may be generated by machine learning using the teacher data D including: information indicating a surrounding situation such as a position, a time zone, or the like in which the missing person is lost, as the second state information; and information indicating a location where the missing person is found, as the second position information. The second state information may include information indicating age of the missing person. For example, the search target may be a lost item, and the time and space in which the search target appears may be a time zone in which the item is lost, or the like. In this case, the search model may be generated by machine learning using the teacher data D including: information indicating a situation such as a time zone in which the item is lost, as the second state information; and information indicating a location where the lost item is found, as the second position information. The second state information may include information indicating the type of the lost item.

### 7: Supplementary Notes

With respect to the example embodiment described above, the following Supplementary Notes are further disclosed.

### Supplementary Note 1

A search apparatus including:
an acquisition unit that acquires first state information indicating a state in a first predetermined range including time and space in which a first search target appears; and
an output unit that outputs first position information indicating a position regarding the first search target located in the first predetermined range, wherein
the output unit inputs the first state information acquired by the acquiring unit into a search model, and causes the search model to output the first position information, and
the search model is generated by machine learning using teacher data including: second state information indicating a state in a second predetermined range including time and space in which a second search target appears; and second position information indicating a position regarding the second search target located in the second predetermined range.

### Supplementary Note 2

The search apparatus according to Supplementary Note 1, further including a model generation unit that adjusts a parameter included in the search model by performing the machine learning using the teacher data including the second state information and the second position information, and generates the search model.

### Supplementary Note 3

The search apparatus according to Supplementary Note 1 or 2, wherein
the first state information is information about an image of the first predetermined range including the time and space in which the first search target appears, and
the second state information is information about an image of the second predetermined range including the time and space in which the second search target appears.

### Supplementary Note 4

The search apparatus according to Supplementary Note 2, further comprising a presentation unit that presents a position indicated by the first position information as an overlooked part that is unlikely to be confirmed by a user who uses the first position information, in a case of the position indicated by the first position information is not confirmed by the user.

### Supplementary Note 5

The search apparatus according to Supplementary Note 4, wherein the presentation unit presents the position indicated by the first position information, as the overlooked part that is unlikely to be confirmed by the user, based on at least one of information about a checklist indicating a position confirmed by the user in the first predetermined range and information about a movement of the user in the first predetermined range.

### Supplementary Note 6

The search apparatus according to Supplementary Note 4 or 5, wherein
the output unit inputs the first state information acquired by the acquiring unit into the search model, and causes the search model to output the first position information and first possibility information about a possibility of the user overlooking the position indicated by the first position information, and
the model generation unit regenerates the search model by machine learning using teacher data including the first state information and the first position information, respectively as the second state information and the second position information, the teacher data further including second possibility information indicating that a possibility of the user overlooking a position indicated by the second position information is greater than a predetermined value, in response to the user finding the first search target at the position indicated by the first position information after the position indicated by the first position information is presented to the user as the overlooked part.

### Supplementary Note 7

A search method including:
acquiring first state information indicating a state in a first predetermined range including time and space in which a first search target appears; and
outputting first position information indicating a position regarding the first search target located in the first predetermined range, wherein
the outputting is performed by inputting the first state information acquired into a search model, and by causing the search model to output the first position information, and
the search model is generated by machine learning using teacher data including: second state information indicating a state in a second predetermined range including time and space in which a second search target appears; and second position information indicating a position regarding the second search target located in the second predetermined range.

### Supplementary Note 8

A recording medium on which a computer program that allows a computer to execute a search method is recorded, the search method including:
acquiring first state information indicating a state in a first predetermined range including time and space in which a first search target appears; and
outputting first position information indicating a position regarding the first search target located in the first predetermined range, wherein
the outputting is performed by inputting the first state information acquired into a search model, and by causing the search model to output the first position information, and
the search model is generated by machine learning using teacher data including: second state information indicating a state in a second predetermined range including time and space in which a second search target appears; and second position information indicating a position regarding the second search target located in the second predetermined range.

Although the present disclosure has been described with reference to the example embodiments, this disclosure is not limited to the above-described example embodiments. Various changes that can be understood by those skilled in the art within the scope of the present disclosure, are allowed to be made in the configuration and details of the present disclosure. Then, each of the example embodiments may be combined with another example embodiment as appropriate. Furthermore, to the extent permitted by law, the disclosures of all documents (e.g., publications) cited in this disclosure above are incorporated into the description of this disclosure.

To the extent permitted by law, this application claims the benefit of priority based on Japanese application No. 2022-104556, filed Jun. 29, 2022, the entire disclosure of which is hereby incorporated by reference.

### Description of Reference Codes

1, 2, 3, 4, 5, 6 Search apparatus
11, 211 Acquisition unit
12, 212 Output unit
213 Model generation unit
414 Presentation unit

What is claimed is:

1. A search apparatus comprising:
at least one memory that is configured to store instructions; and
at least one processor that is configured to execute the instructions to:
acquire first state information indicating a state in a first predetermined range including time and space in which a first search target appears;
output first position information indicating a position regarding the first search target located in the first predetermined range; and
input the first state information acquired into a search model, and cause the search model to output the first position information, wherein
the search model is generated by machine learning using teacher data including: second state information indicating a state in a second predetermined range including time and space in which a second search target appears; and second position information indicating a position regarding the second search target located in the second predetermined range.

2. The search apparatus according to claim 1, wherein the at least one processor is configured to execute the instructions to adjust a parameter included in the search model by performing the machine learning using the teacher data including the second state information and the second position information, and generate the search model.

3. The search apparatus according to claim 1, wherein
the first state information is information about an image of the first predetermined range including the time and space in which the first search target appears, and
the second state information is information about an image of the second predetermined range including the time and space in which the second search target appears.

4. The search apparatus according to claim 2, wherein the at least one processor is configured to execute the instructions to present a position indicated by the first position information as an overlooked part that is unlikely to be confirmed by a user who uses the first position information, in a case of the position indicated by the first position information is not confirmed by the user.

5. The search apparatus according to claim 4, wherein the at least one processor is configured to execute the instructions to present the position indicated by the first position information, as the overlooked part that is unlikely to be confirmed by the user, based on at least one of information about a checklist indicating a position confirmed by the user in the first predetermined range and information about a movement of the user in the first predetermined range.

6. The search apparatus according to claim 4, wherein the at least one processor is configured to execute the instructions to:
input the first state information acquired into the search model, and cause the search model to output the first position information and first possibility information about a possibility of the user overlooking the position indicated; and
regenerate the search model by machine learning using teacher data including the first state information and the first position information, respectively as the second state information and the second position information, the teacher data further including second possibility information indicating that a possibility of the user overlooking a position indicated by the second position information is greater than a predetermined value, in response to the user finding the first search target at the position indicated by the first position information after the position indicated by the first position information is presented to the user as the overlooked part.

7. A search method comprising:
acquiring first state information indicating a state in a first predetermined range including time and space in which a first search target appears; and
outputting first position information indicating a position regarding the first search target located in the first predetermined range, wherein
the outputting is performed by inputting the first state information acquired into a search model, and by causing the search model to output the first position information, and
the search model is generated by machine learning using teacher data including: second state information indicating a state in a second predetermined range including time and space in which a second search target appears; and second position information indicating a position regarding the second search target located in the second predetermined range.

8. A non-transitory recording medium on which a computer program that allows a computer to execute a search method is recorded, the search method including:
acquiring first state information indicating a state in a first predetermined range including time and space in which a first search target appears; and
outputting first position information indicating a position regarding the first search target located in the first predetermined range, wherein
the outputting is performed by inputting the first state information acquired into a search model, and by causing the search model to output the first position information, and
the search model is generated by machine learning using teacher data including: second state information indicating a state in a second predetermined range including time and space in which a second search target appears; and second position information indicating a position regarding the second search target located in the second predetermined range.
